(19) United States
(12) Patent Application Publication
(10) Pub. No.: US 2005/0029062 A1
(43) Pub. Date: Feb. 10, 2005

(54) Front strut air spring suspension system

(76) Inventors: Simon Dean, West Bloomfield, MI (US); Jeff Lloyd, Auburn Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/636,446

(22) Filed: Aug. 7, 2003

(51) Int. Cl. B60G 1/00; B62D 1/00

(52) U.S. Cl. 188/322.12; 267/140.11; 248/638; 280/124.155

(57) ABSTRACT

A steerable front suspension system provides a strut isolator assembly that is supported upon a bearing assembly mounted to a frame bracket. The forces upon a piston rod are transferred to the frame bracket through the strut isolator assembly that is rotationally supported upon the bearing assembly. The forces upon a spring assembly pass through an upper spring mount, a flange portion of the strut isolator assembly, the bearing assembly and into the frame bracket. An air bag is mounted to a jounce bumper bracket. An annular piston rod seal such as an O-ring seal is mounted about a reduced diameter piston rod segment adjacent a step upon which the jounce bumper bracket is located. The air chamber formed by the air bag is thusly sealed to the piston rod by the annular retainer and the annular piston rod seal.

### BACKGROUND OF THE INVENTION

The present invention relates to an air spring suspension system, and more particularly to a steerable front suspension system with an air spring and strut fluid shock absorber that provides dual path isolation.

Conventional suspension struts are commonly constructed with either coil springs or air springs mounted adjacent the strut. A particular problem encountered by front suspension struts that are mounted to the front steerable wheels is that the upper strut mount must rotate to provide steerage of the front wheels. Sealing of the air spring rotating upper mount may create complex, unserviceable and/or costly designs which reduces the usable stroke of the strut.

Another disadvantage with convention suspension units is the difficulty of providing a fluid shock absorber strut in combination with an air spring to provide dual path isolation in a compact package or unit on a steerable air strut. Dual path isolation isolates the strut shaft from the air spring, and the strut shaft is isolated by an elastomer from the vehicle chassis. Heretofore, dual path isolators have been used to reduce ride harshness and noise in strut type applications, but the combination of an air spring in a steerable air strut provides relatively complicated air spring seal arrangements.

Accordingly, it is desirable to provide a steerable front suspension strut with dual path isolation and an uncomplicated air spring seal arrangement.

### SUMMARY OF THE INVENTION

The steerable front suspension system according to the present invention provides dual path isolation. A strut isolator assembly includes an inner annular sleeve and an annular outer bushing which supports a resilient strut isolator therebetween. The annular outer bushing is generally C-shaped in cross-section and is formed about a bearing assembly. A piston rod of a strut is mounted to a frame bracket through the strut isolator assembly.

The forces upon the spring assembly pass through an upper spring mount, a flange portion of the annular outer bushing, the bearing assembly and into the frame bracket. As the strut isolator assembly does not support the spring assembly, the resilient strut isolator is manufactured of a less dense and more resilient material to provide enhanced isolation.

An air bag is mounted to a jounce bumper bracket. An annular piston rod seal such as an O-ring seal is mounted about a reduced diameter piston rod segment adjacent a step upon which the jounce bumper bracket is located. The annular piston rod seal is thereby trapped between the step, the annular opening and the inner annular sleeve of the strut isolator assembly. The air chamber formed by the air bag is thusly sealed to the jounce bumper bracket by the annular retainer and to the piston rod by the annular piston rod seal in a relatively uncomplicated and readily assembled arrangement which avoids sealing at the resilient strut isolator which may be a potential leak path. All the sealing is provided by static seals which limit the risk of leakage.

A conventional coil spring may alternatively be supported between the upper spring mount and a lower spring mount in place of an air bag. This bearing and mount configuration also allows rotation of the entire assembly; including spring, strut and strut rod. The steering friction is thus relatively low as compared to not allowing the strut rod to rotate.

The present invention therefore provides a steerable front suspension strut with dual path isolation and an uncomplicated air spring seal arrangement.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a partial sectional view of a steerable air spring suspension system;

FIG. 2 is an expanded view of an upper mount assembly and air spring assembly;

FIG. 3 is an exploded view of an upper mount assembly and air spring assembly; and

FIG. 4 is a partial sectional view of a steerable suspension system of the present invention with an air spring replaced by a coil spring.

### DETAILED DESCRIPTION OF THE PREFERRED EMBODIMENT

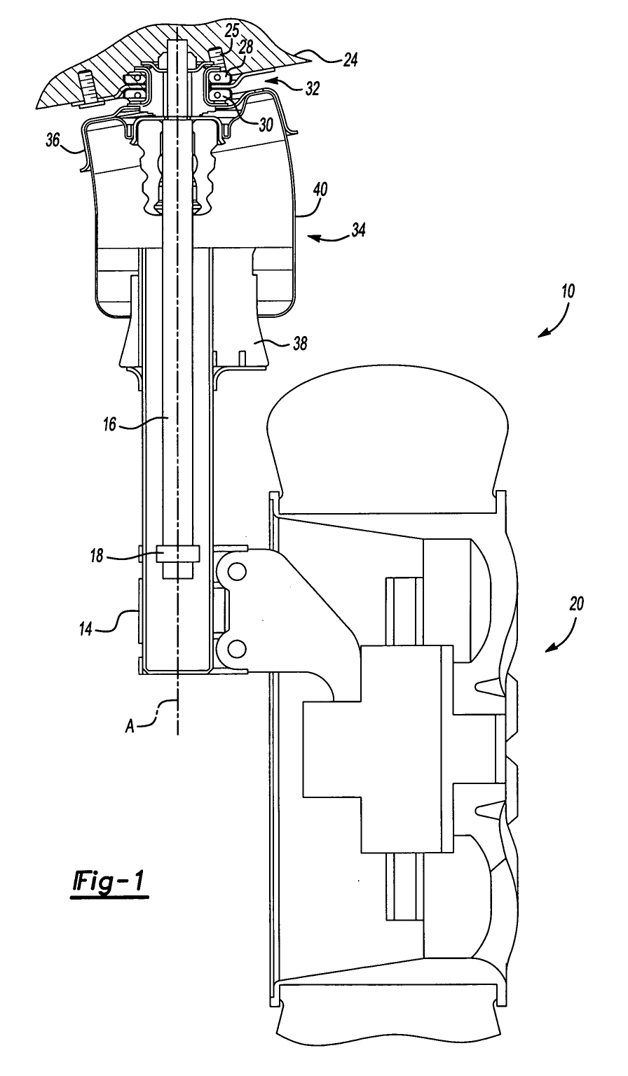

FIG. 1 illustrates a general partial sectional view of a steerable front suspension system 10. The suspension system 10 includes a fluid shock absorber strut 12 which defines an axis A. The strut 12 includes a cylinder 14 and a piston rod 16 reciprocally mounted therein which reciprocates along axis A. A piston 18 (illustrated schematically) is located within cylinder 14 as generally understood. The cylinder 14 is mounted to a wheel assembly 20.

The piston rod 16 is mounted to a frame bracket 22 which is fixed to a vehicle frame 24 (illustrated schematically) by fasteners 25 or the like. A bearing assembly 26 includes a rebound bearing 28 mounted above the frame bracket 22 and a compression bearing 30 mounted below the frame bracket 22 thereby sandwiching the frame bracket 22 therebetween.

The bearing assembly 26 is mounted to the piston rod 16 through an upper mount assembly 32 which mounts an air spring assembly 34 thereto. The upper mount assembly 32 supports an upper spring mount 36 of the air spring assembly 34. An air spring piston 38 of the spring assembly 34 is mounted to the cylinder 14 via a lower spring mount 39 such that an air bag 40 is retained between the upper spring mount 36 and the lower spring mount 39. The air spring piston 38 is sealed to cylinder 14 via an o-ring type seal 41. The upper mount assembly 32 resiliently and rotationally mounts the piston rod 16 to the vehicle.

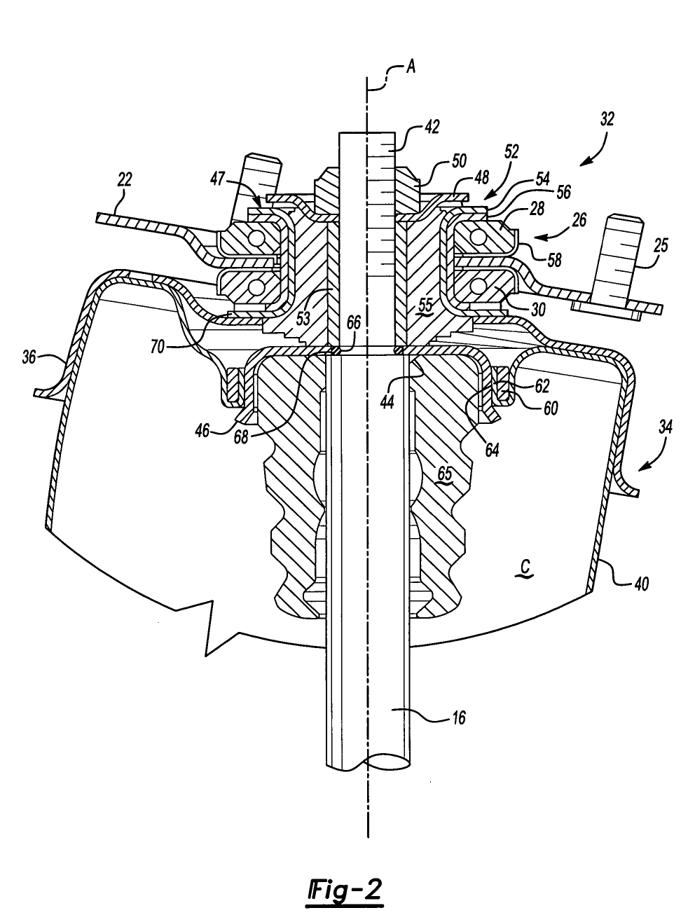

Referring to FIG. 2, the upper mount assembly 32 is mounted to a reduced diameter section 42 of the piston rod 16. The reduced diameter piston rod segment 42 forms a step 44 which supports a jounce bumper bracket 46 thereon. A strut isolator assembly 46 is mounted upon the jounce bumper bracket 46 and axially retained thereto by a washer 48 and nut 50 which threads onto the reduced diameter piston rod segment 42. Other retainers will also benefit from the present invention.

The bearings 28, 30 are mounted to a bushing assembly 52 which fits about the outer perimeter of the strut isolator assembly 46 of the upper mount assembly 32. The strut isolator assembly 46 includes an inner annular sleeve 52 and an annular outer bushing 54 which supports a resilient strut isolator 55 therebetween. The annular outer bushing 54 is generally C-shaped in cross-section and is formed about the bearing assembly 26 therein.

The annular bushing 54 is preferably bonded to the resilient isolator 55 and supports the bearings 28, 30 through a resilient bearing isolator 56 which fits within the annular outer bushing 54. A bearing support bracket 58 is mounted between the bearings 28, 30 and the frame bracket 22 to retain bearings in place.

The annular outer bushing 54 is attached to the upper spring mount 36 though welding or the like. Preferably, a lower portion of the C-shaped annular bushing 54 is mounted to a top portion of the upper spring mount 36. The air bag 40 is mounted to the jounce bumper bracket 46 through an annular retainer 60 such as a ring, clamp, crimp or the like which sandwiches an end segment 62 of the air bag 40 against an outer diameter 64 of the jounce bumper bracket 46. The air bag 40 then travels around the annular retainer 60, upward toward the upper spring mount 36, then contained and redirected around a jounce bumper 65 mounted to the jounce bumper bracket 46 and toward the air spring piston 38 (FIG. 1) where it is attached in a conventional manner.

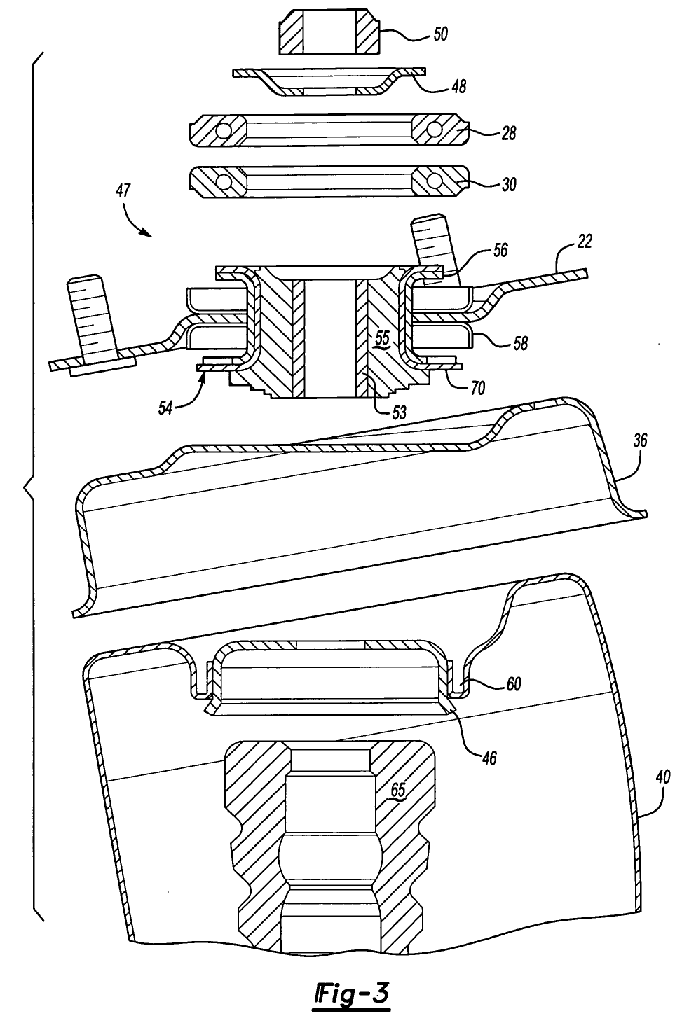

An annular piston rod seal 66 such as an O-ring seal is mounted about the reduced diameter piston rod segment 42 adjacent the step 44. The annular piston rod seal 66 is preferably located within an annular opening 68 of the jounce bumper bracket 46. The annular piston rod seal 66 is thereby trapped between the step 44, the annular opening 68 and the inner annular sleeve 52. The air chamber C formed by the air bag 40 is thusly sealed to the piston rod 16 by the annular retainer 60 and the annular piston rod seal 66 in a relatively uncomplicated and readily assembled arrangement which avoids sealing at the resilient strut isolator 55 which may be a potential leak path. Moreover, the upper mount assembly 32 is serviceable separate from the air spring assembly 34 (FIG. 3).

Dual path isolation is provided by the present invention. The piston rod 16 is mounted to the frame bracket 22 through the strut isolator assembly 46 which is supported upon the bearing assembly 26 mounted to the frame bracket 22. That is, the forces upon the piston rod are transferred to the frame bracket 22 through the strut isolator assembly 46 which is rotationally supported by the bearing assembly 26.

The forces upon the spring assembly 34 pass through the upper spring mount 36, a flange portion 70 of the annular outer bushing 54, the bearing assembly 26 and into the frame bracket 22. As the strut isolator assembly 46 does not support the spring assembly 34, the resilient strut isolator 55 is manufactured of a less dense and more resilient material to provide enhanced isolation.

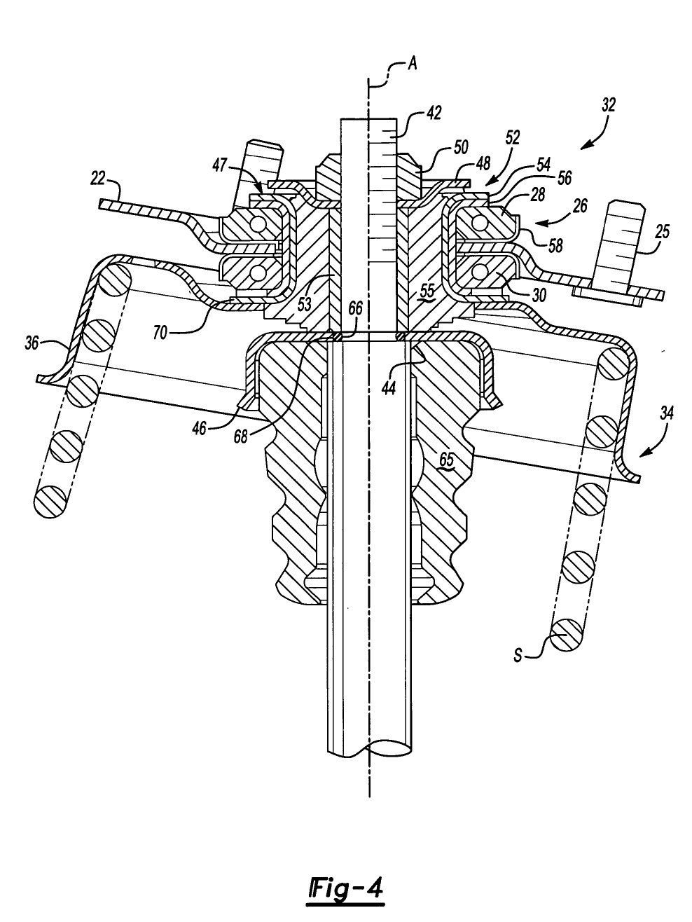

Referring to FIG. 4, a conventional coil spring S may alternatively be supported between the upper spring mount 36 and the lower spring mount 39. That is, the present invention is modular in nature such that either an air bag (FIG. 2) or coil spring (FIG. 4) is readily installed without alteration of the basic structure.

It should be understood that relative positional terms such as “forward,” “aft,” “upper,” “lower,” “above,” “below,” and the like are with reference to the normal operational attitude of the vehicle and should not be considered otherwise limiting.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A dual path isolation upper mount assembly for a steerable suspension system comprising:
a frame bracket;
a bearing assembly rotationally mounted to said frame bracket;
a strut isolator assembly comprising an annular outer bushing supported upon said bearing assembly; and an upper spring mount attached to said annular outer bushing, a flange portion of said annular outer bushing located between said bearing assembly and said upper spring mount.

2. The upper mount assembly as recited in claim 1, wherein said annular outer bushing is substantially C-shaped in cross-section.

3. The upper mount assembly as recited in claim 1, wherein said strut isolator assembly further comprises an inner annular sleeve which supports a resilient strut isolator, said annular outer bushing mounted to said resilient strut isolator.

4. The upper mount assembly as recited in claim 3, further comprising an annular piston rod seal mounted between said inner annular sleeve and said piston rod step.

5. The upper mount assembly as recited in claim 3, wherein said inner annular sleeve mounted between a jounce bumper bracket and a washer.

6. The upper mount assembly as recited in claim 3, further comprising a threaded fastener mounted to a threaded reduced diameter piston rod segment to axially retain said washer.

7. The upper mount assembly as recited in claim 1, further comprising a jounce bumper bracket mounted between an inner annular sleeve of said strut isolator assembly and a piston rod step formed in a piston rod.

8. The upper mount assembly as recited in claim 9, further comprising an air bag attached to an outer surface of said jounce bumper bracket.

9. A steerable suspension system comprising:
a bearing assembly;
a strut isolator assembly comprising an annular outer bushing, an inner annular sleeve and a resilient isolator mounted therebetween, said annular outer bushing supported upon said bearing assembly;
a piston rod comprising a reduced diameter piston rod segment which defines a piston rod step;
a jounce bumper bracket mounted between said inner annular sleeve and said piston rod step; and
an upper spring mount attached to said annular outer bushing, a flange portion of said annular outer bushing located between said bearing assembly and said upper spring mount.

10. The steerable suspension system as recited in claim 9, further comprising an air bag attached to an outer surface of said jounce bumper bracket.

11. The steerable suspension system as recited in claim 9, wherein said annular outer bushing is substantially C-shaped in cross-section.

12. The steerable suspension system as recited in claim 9, further comprising a threaded fastener mounted to a threaded segment of said reduced diameter piston rod segment to axially retain said strut isolator assembly.

13. The steerable suspension system as recited in claim 9, further comprising a coil spring engaged with said upper spring mount.

14. A steerable suspension system comprising:
a strut isolator assembly comprising an annular outer bushing, an inner annular sleeve and a resilient isolator mounted therebetween,
a piston rod comprising a reduced diameter piston rod segment which defines a piston rod step, said inner annular sleeve mounted about said reduced diameter piston rod segment;
a jounce bumper bracket mounted between said inner annular sleeve and said piston rod step;
an air bag attached to an outer surface of said jounce bumper bracket; and
an annular piston rod seal mounted between said inner annular sleeve and said piston rod step, said annular piston rod seal located within an annular opening of said jounce bumper bracket.

15. The steerable suspension system as recited in claim 14, further comprising:
an upper spring mount attached to said annular outer bushing, a flange portion of said annular outer bushing located between said compression bearing and said upper spring mount.
